(19) United States
(12) Patent Application Publication
(10) Pub. No.: US 2014/0300710 A1
(43) Pub. Date: Oct. 9, 2014

(54) DISPLAY UNIT AND ELECTRONIC APPARATUS

(71) Applicant: Sony Corporation, Tokyo (JP)

(72) Inventors: Masaki Shinoda, Mie (JP); Kouta Okabe, Gifu (JP); Takao Sumida, Aichi (JP)

(73) Assignee: Sony Corporation, Tokyo (JP)

(21) Appl. No.: 14/355,003

(22) PCT Filed: Oct. 12, 2012
(86) PCT No.: PCT/JP2012/076522

§ 371 Date: Apr. 29, 2014

(30) Foreign Application Priority Data
Nov. 10, 2011 (JP) 2011-246775

(51) Int. Cl. H04N 13/04

(52) U.S. Cl. CPC H04N 13/04
USPC 348/51

(57) ABSTRACT

There is provided a display unit that achieves more favorable image. This display unit includes: an illumination unit including a light-guiding plate; and a display section adhered to the light-guiding plate to face the light-guiding plate, and performing image display by utilizing light from the light-guiding plate. The light-guiding plate has first and second internal reflection surfaces facing each other. At least one of the first and second internal reflection surfaces is provided with a plurality of scattering regions that scatter first illumination light from outside and allow scattered light travelling from the first internal reflection surface towards the display section to be emitted.

### TECHNICAL FIELD

The present disclosure relates to a display unit and an electronic apparatus including the display unit.

### BACKGROUND ART

As a display unit of recent years, for example, a non-light-emitting-type display unit such as a liquid crystal display may be known, in addition to, for example, a self-light-emitting-type display unit such as a plasma display and an organic EL display. Among them, the liquid crystal display may include, for example, a liquid crystal panel that serves as a transmission-type light modulation device, and a backlight unit that irradiates the liquid crystal panel with illumination light. In the liquid crystal panel, a predetermined image is displayed by controlling transmittance of the illumination light coming from the backlight unit.

In order to respond to recent demand for a reduction in thickness of a display unit, there has been already proposed a structure in which a light-guiding plate is disposed behind a liquid crystal panel (on a side opposite to a display surface), and a light source of a backlight unit is disposed to face an end face of the light-guiding plate (see, for example, Patent Literatures 1 and 2).

In addition, in recent years, there has been developed a stereoscopic display unit adopting a parallax barrier system that allows stereoscopic vision with naked eyes, without wearing special glasses. In this stereoscopic display unit, a parallax barrier may be disposed, for example, in front of a two-dimensional display panel (between a display surface and a viewer), to face the two-dimensional display panel. In a general configuration of the parallax barrier, blocking sections that block display image light coming from the two-dimensional display panel, and stripe-shaped opening sections (slit sections) that allow the display image light to pass therethrough, are provided alternately in a horizontal direction.

In the parallax barrier system, stereoscopic vision is achieved by space-divisionally displaying a parallax image for stereoscopic vision (a perspective image for a right eye and a perspective image for a left eye in a case with two perspectives), and performing parallax separation of this parallax image in the horizontal direction by using the parallax barrier. By appropriately setting a slit width, etc. in the parallax barrier, it is possible to allow light of different parallax images to be separately incident on the right and left eyes of the viewer through the slit section, when the viewer views the stereoscopic display unit from a predetermined position or direction.

It is to be noted that, when, for example, a transmission-type liquid-crystal display panel is used as the two-dimensional display panel, a configuration in which the parallax barrier is disposed on a back face side of the two-dimensional display panel may also be adopted. In this case, the parallax barrier is disposed between the transmission-type liquid-crystal display panel and a backlight.

### CITATION LIST

### Patent Literature

Patent Literature 1: Japanese Unexamined Patent Application Publication No. 2009-110811

Patent Literature 2: Japanese Unexamined Patent Application Publication No. 2009-32664

### SUMMARY OF THE INVENTION

However, in the stereoscopic display unit of the parallax barrier system as described above, a component dedicated to three-dimensional display, i.e. the parallax barrier, is used and therefore, there is such a disadvantage that the number and arrangement space of components are large as compared with an ordinary display unit for two-dimensional display.

Hence, it is desirable to provide a display unit and an electronic apparatus that are capable of achieving a function equivalent to a parallax barrier with the use of a light-guiding plate, and also capable of forming a highly-accurate parallax image.

A display unit according to an embodiment of the present disclosure includes: an illumination unit including a light-guiding plate; and a display section adhered to the light-guiding plate to face the light-guiding plate, and performing image display by utilizing light from the light-guiding plate. The light-guiding plate has first and second internal reflection surfaces facing each other. At least one of the first and second internal reflection surfaces is provided with a plurality of scattering regions that scatter first illumination light from outside and allow scattered light travelling from the first internal reflection surface towards the display section to be emitted. Further, an electronic apparatus according to an embodiment of the present disclosure includes the above-described display unit.

In the display unit and the electronic apparatus according to the embodiments of the present disclosure, the first illumination light is scattered by the scattering regions, and part or all of light is emitted from the first internal reflection surface to outside of the light-guiding plate. This allows the light-guiding plate itself to have a function as a parallax barrier. In other words, this allows the light-guiding plate to serve equivalently as the parallax barrier in which the scattering region is used as an opening section (a slit section). Moreover, the light-guiding plate and the display section are adhered to each other, and therefore, relative positions of the parallax barrier formed in the light-guiding plate and the display section are maintained with high accuracy.

According to the display unit and the electronic apparatus of the embodiments of the present disclosure, the light-guiding plate itself provided with the scattering regions is allowed to exhibit a function as the parallax barrier. Therefore, as compared with a case in which a parallax barrier is provided as a separate component, the number of components is allowed to be reduced and a reduction in thickness is achievable. Further, by a configuration in which such a light-guiding plate and the display section are adhered to each other, accuracy of relative positions thereof is allowed to be improved and a more precise parallax image is achievable.

### BRIEF DESCRIPTION OF THE DRAWINGS

FIG. 1 is a cross-sectional diagram illustrating a configuration example of a display unit according to an embodiment of the present disclosure, together with an emission state of light rays from a light source device when only a first light source is in an ON (lighting) state.

FIG. 2 is a cross-sectional diagram illustrating a configuration example of the display unit illustrated in FIG. 1, together with an emission state of light rays from the light source device when only a second light source is in an ON (lighting) state.

FIG. 3 is a cross-sectional diagram illustrating a configuration example of the display unit illustrated in FIG. 1, together with an emission state of light rays from the light source device when both the first light source and the second light source are in the ON (lighting) state.

FIG. 4 is a plan view illustrating a configuration example of the display unit illustrated in FIG. 1.

FIG. 5 is a cross-sectional diagram illustrating a first modification of the display unit illustrated in FIG. 1.

FIG. 6 is a cross-sectional diagram illustrating a second modification of the display unit illustrated in FIG. 1.

FIG. 7 includes a cross-sectional diagram illustrating a first configuration example of a light-guiding plate surface in the display unit illustrated in FIG. 1, and an explanatory diagram schematically illustrating a scattering reflection state of light rays at the light-guiding plate surface.

FIG. 8 includes a cross-sectional diagram illustrating a second configuration example of the light-guiding plate surface in the display unit illustrated in FIG. 1, and an explanatory diagram schematically illustrating a scattering reflection state of light rays at the light-guiding plate surface.

FIG. 9 includes a cross-sectional diagram illustrating a third configuration example of the light-guiding plate surface in the display unit illustrated in FIG. 1, and an explanatory diagram schematically illustrating a scattering reflection state of light rays at the light-guiding plate surface.

FIG. 10 is a plan view illustrating an example of a pixel configuration of a display section.

FIG. 11 includes a plan view and a cross-sectional diagram illustrating a first example of a correspondence between an assignment pattern in a case in which two perspective images are assigned, and an arrangement pattern of a scattering region, in the pixel configuration of FIG. 10.

FIG. 12 is a perspective view illustrating a configuration of a television apparatus serving as an electronic apparatus using a display unit.

FIG. 13 is a plan view illustrating a third modification of the display unit illustrated in FIG. 1.

### MODES FOR CARRYING OUT THE INVENTION

An embodiment of the present technology will be described below in detail with reference to the drawings.

[Overall Configuration of Display Unit]

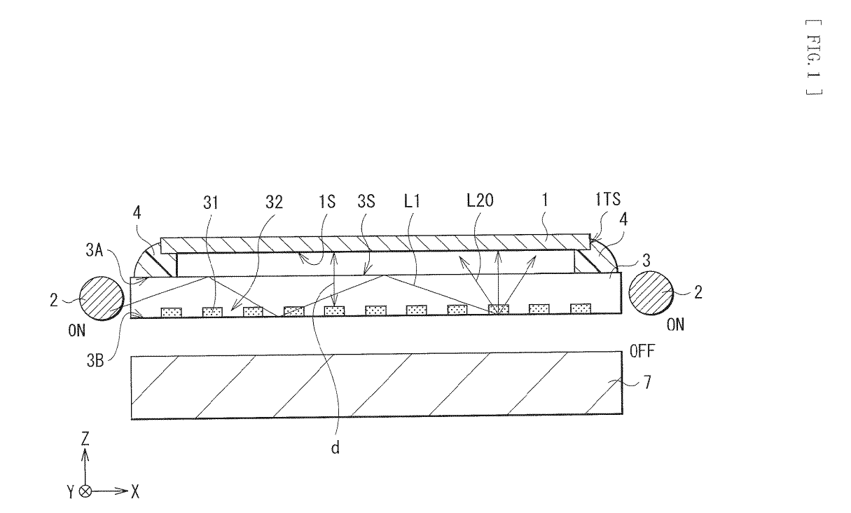

FIGS. 1 to 3 each illustrate a configuration example of a display unit according to an embodiment of the present disclosure. This display unit includes a display section 1 performing image display, and an illumination unit disposed on a back face side of the display section 1 and emitting light for image display towards the display section 1. The illumination unit includes a first light source 2 (a 2D/3D-display light source), a light-guiding plate 3, and a second light source 7 (a 2D-display light source). The light-guiding plate 3 includes a first internal reflection surface 3A disposed to face the display section 1, and a second internal reflection surface 3B disposed to face the second light source 7. The display section 1 and the light-guiding plate 3 are adhered to each other to face each other by an adhesion member 4 (FIG. 1). Here, there is a fine space between the display section 1 and the light-guiding plate 3. However, a thickness of the space (i.e., a gap between the display section 1 and the light-guiding plate 3) illustrated in FIG. 1 is large relative to a thickness of each of the display section 1 and the light-guiding plate 3, to describe a path of a light ray. Further, besides these, this display unit includes a control circuit or the like that controls the display section 1 used for display, but the configuration thereof is similar to that of a typical control circuit or the like for display and therefore, the description thereof will be omitted. Furthermore, a light source device include a control circuit that performs ON/OFF (lighting/non-lighting) control of the first light source 2 and the second light source 7, although the control circuit is not illustrated.

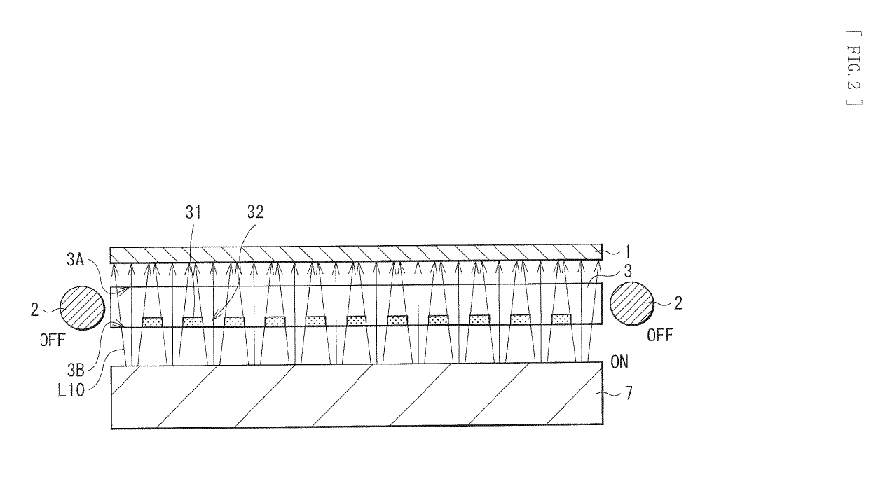

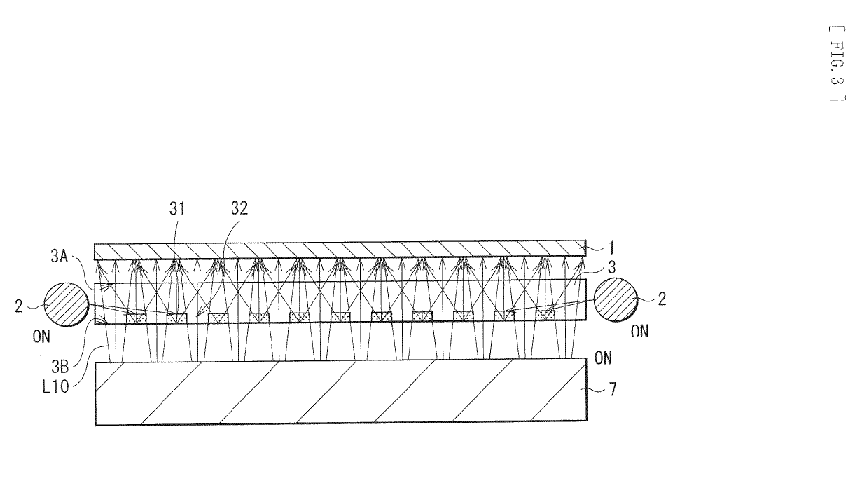

This display unit is capable of performing arbitrary and selective switching between a full-screen two-dimensional (2D) display mode and a full-screen three-dimensional (3D) display mode. The switching between the two-dimensional display mode and the three-dimensional display mode is achieved by performing switching control of image data to be displayed on the display section 1, and ON/OFF switching control of the first light source 2 and the second light source 7. FIG. 1 schematically illustrates an emission state of light rays from the light source device when only the first light source 2 is in the ON (lighting) state, and this corresponds to the three-dimensional display mode. FIG. 2 schematically illustrates an emission state of light rays from the light source device when only the second light source 7 is in the ON (lighting) state, and this corresponds to the two-dimensional display mode. Further, FIG. 3 schematically illustrates an emission state of light rays from the light source device when both the first light source 2 and the second light source 7 are in the ON (lighting) state, and this also corresponds to the two-dimensional display mode.

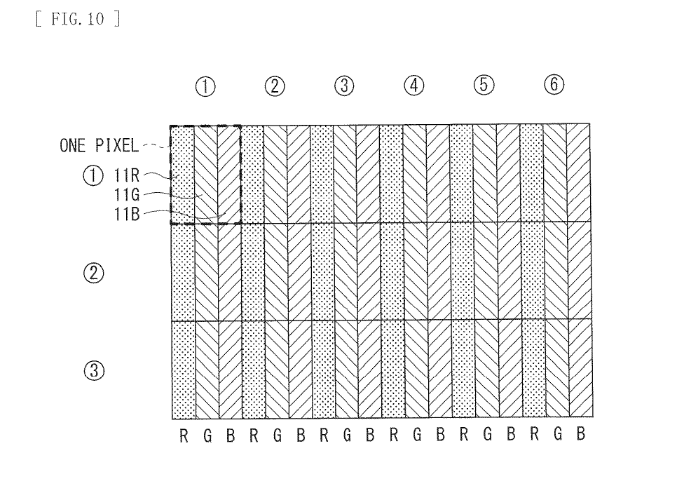

The display section 1 may be configured using a transmission-type two-dimensional display panel, for example, a transmission-type liquid-crystal display panel. The display section 1 may include a plurality of pixels each including a R (red) display pixel 11R, a G (green) display pixel 11G, and a B (blue) display pixel 11B arranged in a matrix, for example, as illustrated in FIG. 10. The display section 1 performs two-dimensional image display by modulating light from the light source device for each of the pixels according to image data. On the display section 1, a plurality of perspective images based on three-dimensional image data and an image based on two-dimensional image data are displayed in an arbitrary and selective switching manner. It is to be noted that the three-dimensional image data may be, for example, data including a plurality of perspective images corresponding to a plurality of viewing-angle directions in the three-dimensional display. For example, when binocular three-dimensional display is performed, the three-dimensional image data may be data of perspective images for right-eye display and left-eye display. When display in the three-dimensional display mode is performed, for example, a composite image in which stripe-shaped perspective images are included in one screen may be generated and displayed. It is to be noted that there is a correspondence between an assignment pattern for assignment of the plurality of perspective images to the respective pixels of the display section 1, and an arrangement pattern of a scattering region 31, and a specific example of this correspondence will be described in detail later.

The first light source 2 may be configured, for example, using a fluorescent lamp such as CCFL (Cold Cathode Fluorescent Lamp), an LED (Light Emitting Diode), or the like. The first light source 2 applies first illumination light L1 (FIG. 1) from a side-face direction towards inside of the light-guiding plate 3. At least one first light source 2 is disposed on a side face of the light-guiding plate 3. For example, when a planar shape of the light-guiding plate 3 is a rectangle, there are four side faces. However, it is enough that the first light source 2 is disposed on at least one of the side faces. FIG. 1 illustrates a configuration example in which the first light source 2 is disposed on each of two opposed side faces of the light-guiding plate 3. The ON/OFF (lighting/non-lighting) control of the first light source 2 is performed according to the switching between the two-dimensional display mode and the three-dimensional display mode. Specifically, the first light source 2 is controlled to be in the lighting state when the display section 1 displays an image based on the three-dimensional image data (in the case of the three-dimensional display mode), and the first light source 2 is controlled to be in the non-lighting state (a light extinction state) or in the lighting state when the display section 1 displays an image based on the two-dimensional image data (in the case of the two-dimensional display mode).

The second light source 7 is disposed to face a side, on which the second internal reflection surface 3B is formed, of the light-guiding plate 3. The second light source 7 applies second illumination light L10 (see FIGS. 2 and 3) from outside to the second internal reflection surface 3B. The second light source 7 may be any surface light source that emits light of uniform in-plane luminance, and the structure thereof is not limited in particular, and a commercially-available surface backlight may be used. For example, it is conceivable to use a structure in which a light-emitting body such as CCFL and LED and a light diffuser that makes in-plane luminance uniform are used, or the like. The ON/OFF (lighting/non-lighting) control of the second light source 7 is performed according to the switching between the two-dimensional display mode and the three-dimensional display mode. Specifically, the second light source 7 is controlled to be in a non-lighting state (a light extinction state) when the display section 1 displays an image based on the three-dimensional image data (in the case of the three-dimensional display mode), and the second light source 7 is controlled to be in a lighting state when the display section 1 displays an image based on the two-dimensional image data (in the case of the two-dimensional display mode).

The light-guiding plate 3 may be configured of, for example, a transparent plastic plate made of acrylic resin or the like. Of the light-guiding plate 3, surfaces except the second internal reflection surface 3B are entirely transparent. For example, when the planar shape of the light-guiding plate 3 is a rectangle, the first internal reflection surface 3A and the four side faces may be entirely transparent.

The entire first internal reflection surface 3A has been subjected to minor-like finishing. The first internal reflection surface 3A causes total internal reflection of a light ray incident at an incident angle meeting a total reflection condition inside the light-guiding plate 3, and allows a light ray failing to meet the total reflection condition to be emitted outside.

The second internal reflection surface 3B includes the scattering region 31 and a total reflection region 32. As will be described later, the scattering region 31 may be formed, for example, by subjecting the surface of the light-guiding plate 3 to laser beam processing, sandblasting, or coating, or by affixing a sheet-like light scattering member to the surface of the light-guiding plate 3. At the second internal reflection surface 3B, the scattering region 31 in the three-dimensional display mode serves as an opening section (a slit section) of a parallax barrier with respect to the first illumination light L1 from the first light source 2, and the total reflection region 32 serves as a blocking section. At the second internal reflection surface 3B, the scattering region 31 and the total reflection region 32 are provided in a pattern forming a structure corresponding to the parallax barrier. In other words, the total reflection region 32 is provided in a pattern corresponding to the blocking section in the parallax barrier, and the scattering region 31 is provided in a pattern corresponding to the opening section in the parallax barrier. It is to be noted that, as a barrier pattern of the parallax barrier, various types of patterns may be used, including a stripe pattern in which multiple opening sections each shaped like a vertically long slit are arranged in parallel in a horizontal direction, with blocking sections in between. However, the barrier pattern is not limited to a particular pattern.

The first internal reflection surface 3A and the total reflection region 32 in the second internal reflection surface 3B cause total internal reflection of a light ray incident at an incident angle θ1 meeting the total reflection condition (cause the total internal reflection of the light ray incident at the incident angle θ1 larger than a predetermined critical angle α). Therefore, the first illumination light L1 coming from the first light source 2 and incident at the incident angle θ1 meeting the total reflection condition is guided in the side-face direction by the total internal reflection, between the first internal reflection surface 3A and the total reflection region 32 in the second internal reflection surface 3B. As illustrated in FIG. 2 or FIG. 3, the total reflection region 32 also allows the second illumination light L10 from the second light source 7 to pass therethrough, and allows the second illumination light L10 to be emitted towards the first internal reflection surface 3A, as a light ray failing to meet the total reflection condition.

It is to be noted that, when a refractive index of the light-guiding plate 3 is assumed to be n1, and a refractive index of an outer medium (an air layer) of the light-guiding plate 3 is assumed to be n0 (<n1), the critical angle α is expressed as follows. Each of α and θ1 is assumed to be an angle with respect to a normal of the surface of the light-guiding plate. The incident angle θ1 meeting the total reflection condition is θ1>α.

sin α=n0/n1

As illustrated in FIG. 1, the scattering region 31 causes scattering reflection of the first illumination light L1 from the first light source 2, and allows at least part of the first illumination light L1 to be emitted towards the first internal reflection surface 3A, as a light ray (a scattering light ray L20) failing to meet the total reflection condition.

[Configuration Example of Adhesion Member 4]

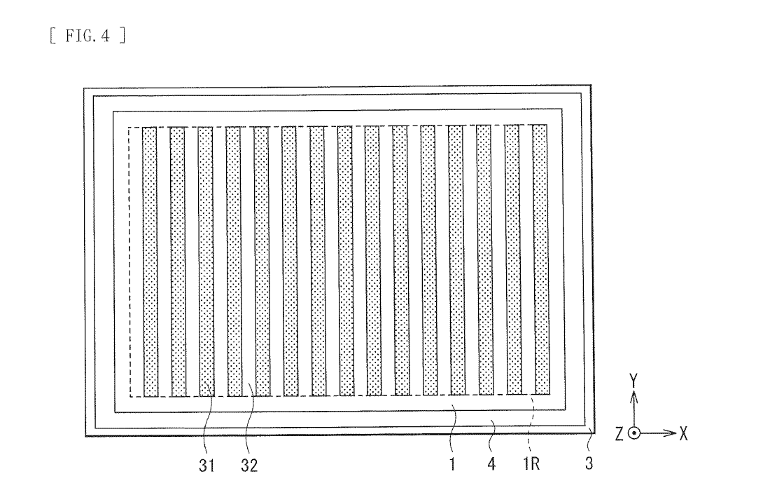

The adhesion member 4 may be, for example, an adhesive made of an ultraviolet-curable-type or thermal-effect-type epoxy resin. The adhesion member 4 may be, for example, provided to connect a peripheral edge portion of the display section 1 and a peripheral edge portion of the light-guiding plate 3. In other words, the light-guiding plate 3 and the display section 1 are adhered by the adhesion member 4, in the whole or a part of a peripheral region surrounding an effective display region 1R. Here, for example, in a case in which the adhesion member 4 is provided to surround the effective display region 1R continuously without a break as illustrated in FIG. 4, entrance of moisture or foreign matter from the outside is avoided and therefore, this case may be preferable.

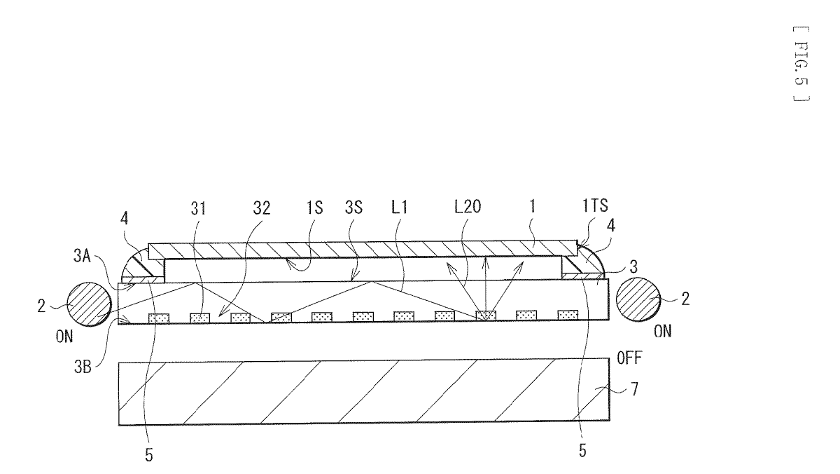

Further, the adhesion member 4 may desirably have a property of absorbing or reflecting visible light. This is to prevent the first illumination light L1 from the first light source 2 from becoming unnecessary light (stray light) reaching a viewer directly or reaching the viewer by passing through the display section 1, after passing through the first internal reflection surface 3A of the light-guiding plate 3 and traveling towards the adhesion member 4. Such stray light may cause deterioration in image quality, such as a reduction in contrast of a displayed image, and may be desirably removed. Such an adhesion member 4 having light blocking characteristics may be configured using, for example, an adhesive containing carbon black. It is to be noted that, even if the adhesion member 4 of a transparent type is used, a thin film 5 having light blocking characteristics, such as a black matrix, may be provided beforehand between the adhesion member 4 and an opposing surface 3S of the light-guiding plate 3, as in a first modification illustrated in FIG. 5, for example. Also in this case as well, it is possible to avoid the stray light. Further, if the adhesion member 4 or the thin film 5 is configured using, for example, a material having high reflectance such as Ag (silver) and Al (aluminum), it is possible to return the first illumination light L1 from the light-guiding plate 3, to the inside of the light-guiding plate 3, which improves utilization efficiency of light.

Alternatively, even if the adhesion member 4 of a transparent type is used, it is fine if the adhesion member 4 has a refractive index lower than that of the light-guiding plate 3, with respect to visible light. This is because, in this case, when an incident angle of the first illumination light L1 with respect to the first internal reflection surface 3A meets a total reflection condition between the light-guiding plate 3 and the adhesion member 4, stray light entering the adhesion member 4 after passing through the first internal reflection surface 3A is avoided. It is to be noted that, if the adhesion member 4 has a refractive index lower than that of the light-guiding plate 3 and is transparent, it is possible to provide the adhesion member 4 so that the adhesion member 4 fill the entire space between the display section 1 and the light-guiding plate 3. In other words, it is possible to adhere the display section 1 and the light-guiding plate 3 to each other entirely including the effective display region 1R, and to adhere the display section 1 and the light-guiding plate 3 to each other more firmly. Even in that case, a light ray (the diffusion light ray L20) failing to meet the total reflection condition for the first internal reflection surface 3A is allowed to pass through the effective display region 1R and to travel towards the display section 1 and therefore, a display function is ensured.

The adhesion member 4 may be provided, for example, in contact with each of an opposing surface 1S of the display section 1 and the opposing surface S3 of the light-guiding plate 3, and also in contact with an end face (in FIG. 1, an end face 1TS of the display section 1) of at least one of the light-guiding plate 3 and the display section 1. Such a structure allows the display section 1 and the light-guiding plate 3 to be adhered to each other more firmly, while keeping the effective display region 1R in the display section 1 to be larger.

[Modification of Configuration of Display Unit]

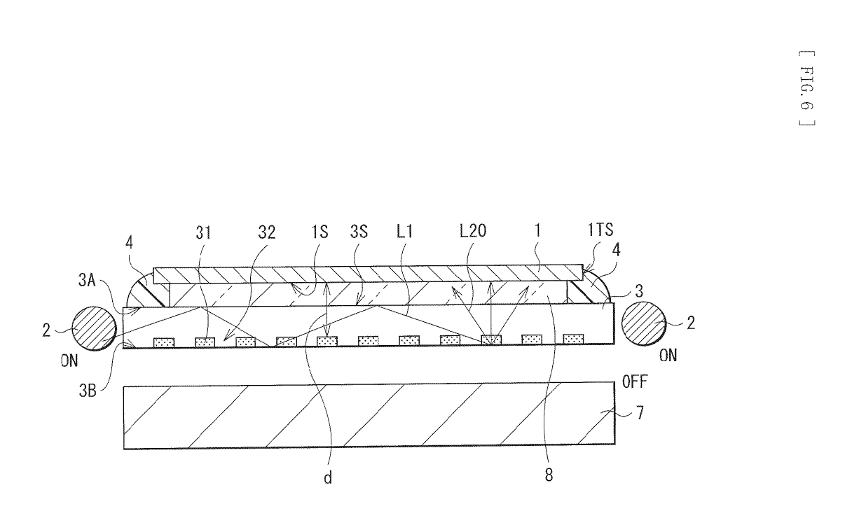

In the display unit illustrated in FIG. 1, in order to perform space separation of the plurality of perspective images displayed on the display section 1, a pixel section of the display section 1 and the scattering region 31 of the light-guiding plate 3 may be preferably disposed to face each other while keeping a predetermined distance d. In FIG. 1, between the display section 1 and the light-guiding plate 3 is an air space. However, as illustrated in a second modification in FIG. 6, a spacer 8 may be disposed between the display section 1 and the light-guiding plate 3, to keep the predetermined distance d. The spacer 8 may be any colorless and transparent material that causes a small amount of scattering, and, for example, PMMA may be used. This spacer 8 may be provided to fully cover both the surface on a back face side of the display section 1 and the surface of the light-guiding plate 3, or may be provided partially to a minimum extent in order to keep the distance d.

[Configuration Example of Scattering Region 31]

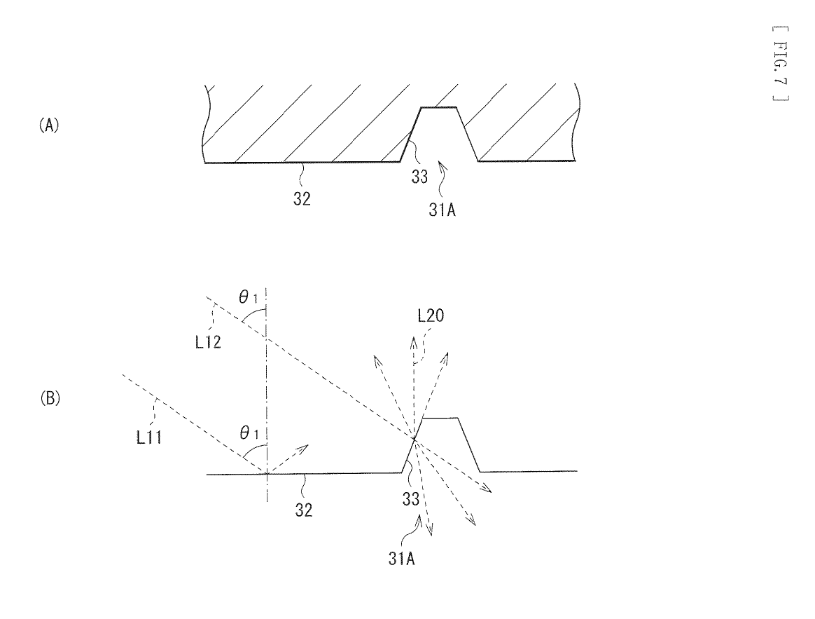

Part (A) of FIG. 7 illustrates a first configuration example of the second internal reflection surface 3B in the light-guiding plate 3. Part (B) of FIG. 7 schematically illustrates a reflection state and a scattering state of light rays at the second internal reflection surface 3B in the first configuration example illustrated in Part (A) of FIG. 7. In this first configuration example, a scattering region 31A that is concave relative to the total reflection region 32 is provided as the scattering region 31. Such a concave scattering region 31A may be formed, for example, by sandblasting, laser beam processing, or the like. For example, the scattering region 31A may be formed by subjecting the surface of the light-guiding plate 3 to minor-like finishing, and then subjecting a part corresponding to the scattering region 31A to the laser beam processing. In the case of this first configuration example, the first illumination light L11 from the first light source 2 incident at the incident angle θ1 meeting the total reflection condition is internally and totally reflected in the total reflection region 32 at the second internal reflection surface 3B. On the other hand, at the concave scattering region 31A, even if light rays of first illumination light L12 is incident at the same incident angle θ1 as that in the total reflection region 32, part of the incident light ray of the first illumination light L12 does not meet the total reflection condition at a side face part 33 of the concave shape, and some passes therethrough while being scattered, whereas the rest is reflected and scattered. Part or all of this reflected and scattered light rays (the diffusion light rays L20) is allowed to be emitted towards the first internal reflection surface 3A, as light rays failing to meet the total reflection condition, as illustrated in FIG. 1.

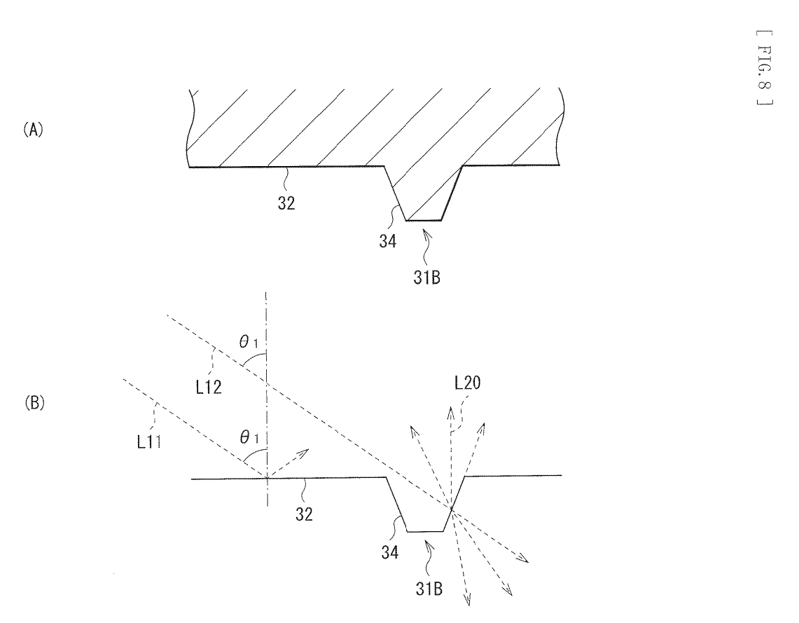

Part (A) of FIG. 8 illustrates a second configuration example of the second internal reflection surface 3B in the light-guiding plate 3. Part (B) of FIG. 8 schematically illustrates a reflection state and a scattering state of light rays at the second internal reflection surface 3B in the second configuration example illustrated in Part (A) of FIG. 8. In this second configuration example, a scattering region 31B that is convex relative to the total reflection region 32 is provided as the scattering region 31. Such a convex scattering region 31B may be formed, for example, by subjecting the surface of the light-guiding plate 3 to molding with a die. In this case, a part corresponding to the total reflection region 32 is subjected to minor-like finishing by a surface of the die. In the case of this second configuration example, at the second internal reflection surface 3B, the first illumination light L11 from the first light source 2 incident at the incident angle θ1 meeting the total reflection condition is internally and totally reflected in the total reflection region 32. On the other hand, at the convex scattering region 31B, even if light rays of the first illumination light L12 are incident at the same incident angle θ1 as that in the total reflection region 32, part of the incident light rays of the first illumination light L12 does not meet the total reflection condition at a side face part 34 of the convex shape, and some passes therethrough while being scattered, whereas the rest is reflected and scattered. Part or all of this reflected and scattered light rays (scattered light rays 20) is allowed to be emitted towards the first internal reflection surface 3A, as light rays failing to meet the total reflection condition, as illustrated in FIG. 1.

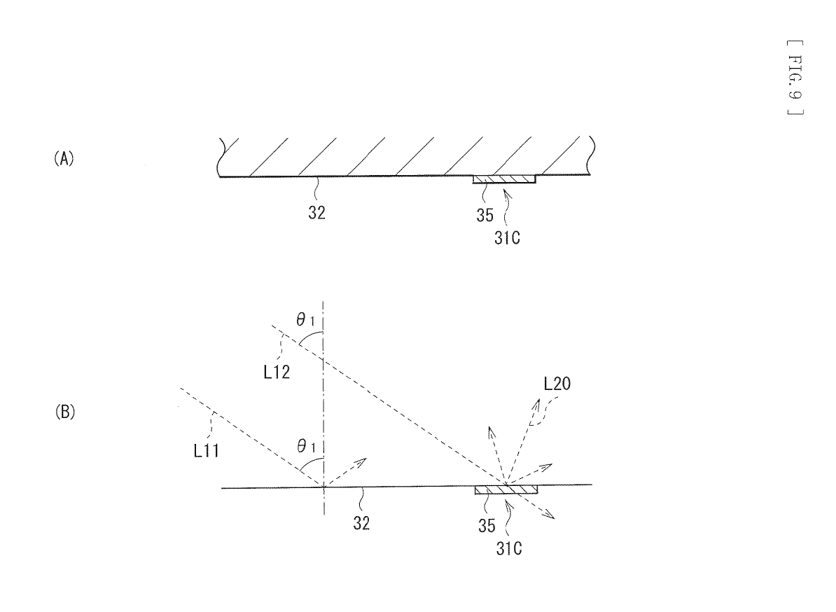

Part (A) of FIG. 9 illustrates a third configuration example of the second internal reflection surface 3B in the light-guiding plate 3. Part (B) of FIG. 9 schematically illustrates a reflection state and a scattering state of light rays in the second internal reflection surface 3B in the third configuration example illustrated in Part (A) of FIG. 9. In the configuration examples in Part (A) of FIG. 7 and Part (A) of FIG. 8, the scattering region 31 is formed by processing the surface of the light-guiding plate 3 into a shape different from that of the total reflection region 32. In contrast, a scattering region 31C in the configuration example of Part (A) of FIG. 9 is not formed by processing the surface. The scattering region 31C is formed by providing a light scattering member 35 made of a material different from that of the light-guiding plate 3, on the surface, of the light-guiding plate 3, corresponding to the second internal reflection surface 3B. In this case, the scattering region 31C may be formed by, for example, patterning a white paint (for example, barium sulfate) on the surface of the light-guiding plate 3 by screen printing, to provide the light scattering member 35. In the case of this third configuration example, at the second internal reflection surface 3B, the first illumination light L11 from the first light source 2 incident at the incident angle θ1 meeting the total reflection condition is internally and totally reflected in the total reflection region 32. On the other hand, in the scattering region 31C where the light scattering member 35 is disposed, even if the first illumination light L12 is incident at the same incident angle θ1 as that in the total reflection region 32, some passes therethrough while being scattered, whereas the rest is reflected and scattered, by the light scattering member 35. Part or all of these reflected and scattered light rays is allowed to be emitted towards the first internal reflection surface 3A, as light rays failing to meet the total reflection condition.

[Basic Operation of Display Unit]

In this display unit, when display is performed in the three-dimensional display mode, an image based on the three-dimensional image data is displayed on the display section 1, and the ON/OFF (lighting/non-lighting) control of the first light source 2 and the second light source 7 is performed for the three-dimensional display. Specifically, as illustrated in FIG. 1, the first light source 2 is controlled to be in the ON (lighting) state, and the second light source 7 is controlled to be in the OFF (non-lighting) state. In this state, the first illumination light L1 from the first light source 2 is internally and totally reflected in a repeated manner between the first internal reflection surface 3A and the total reflection region 32 of the second internal reflection surface 3B in the light-guiding plate 3. As a result, the first illumination light L1 is guided from one side face on a side where the first light source 2 is disposed, towards the other side face facing thereto, and then outputted from the other side face. On the other hand, part of the first illumination light L1 emitted by the first light source 2 is reflected and scattered in the scattering region 31 of the light-guiding plate 3, thereby being allowed to pass through the first internal reflection surface 3A of the light-guiding plate 3 and then emitted to the outside of the light-guiding plate 3. This allows the light-guiding plate itself to have a function of the parallax barrier. In other words, for the first illumination light L1 emitted by the first light source 2, the light-guiding plate is allowed to serve equivalently as the parallax barrier in which the scattering region 31 is used as the opening section (the slit section), and the total reflection region 32 is used as the blocking section. Therefore, equivalently, the three-dimensional display by a parallax barrier system in which a parallax barrier is disposed on the back face side of the display section 1 is performed.

On the other hand, when the display in the two-dimensional display mode is performed, an image based on the two-dimensional image data is displayed on the display section 1, and the ON/OFF (lighting/non-lighting) control of the first light source 2 and the second light source 7 is performed for the two-dimensional display. Specifically, for example, as illustrated in FIG. 2, the first light source 2 may be controlled to be in the OFF (non-lighting) state, and the second light source 7 may be controlled to be in the ON (lighting) state. In this case, the second illumination light L10 from the second light source 7 passes through the total reflection region 32 in the second internal reflection surface 3B, thereby being emitted from almost the entire first internal reflection surface 3A to the outside of the light-guiding plate 3, as light rays failing to meet the total reflection condition. In other words, the light-guiding plate 3 functions as a surface light source similar to an ordinary backlight. Therefore, equivalently, the two-dimensional display in a backlight system in which an ordinary backlight is disposed on a back face side of the display section 1 is performed.

It is to be noted that even if only the second light source 7 is turned on, the second illumination light L10 is emitted from almost the entire surface of the light-guiding plate 3, but the first light source 2 may be turned on as necessary as illustrated in FIG. 3. For example, assume a case in which a difference in luminance distribution occurs between a part corresponding to the scattering region 31 and a part corresponding to the total reflection region 32 when only the second light source 7 is turned on. In this case, it is possible to optimize the luminance distribution over the entire surface, by adjusting the lighting state of the first light source 2 appropriately (by adjusting the ON/OFF control or the quantity of lighting). However, when the two-dimensional display is performed, if, for example, the luminance may be sufficiently corrected on the display section 1 side, only the second light source 7 may be turned on.

[Correspondence Between Assignment Pattern of Perspective Image and Arrangement Pattern of Scattering Region 31]

In this display unit, when display is performed in the three-dimensional display mode, the display section 1 displays the plurality of perspective images that are assigned to the respective pixels by a predetermined assignment pattern. A plurality of the scattering regions 31 in the light-guiding plate 3 are provided in a predetermined arrangement pattern corresponding to the predetermined assignment pattern.

A specific example of the correspondence between the assignment pattern of the perspective images and the arrangement pattern of the scattering regions 31 will be described below. As illustrated in FIG. 10, the display section 1 has a pixel configuration in which the plurality of pixels each including the pixel 11R for red, the pixel 11G for green, and the pixel 11B for blue are provided and arranged in a first direction (a vertical direction) and a second direction (a horizontal direction) to be in a matrix. The respective pixels 11R, 11G, and 11B of three colors are periodically and alternately arranged in the horizontal direction, and the respective pixels 11R, 11G, and 11B are arranged on the same color basis in the vertical direction. In the case of this pixel configuration, in a state in which the display section 1 displays a usual two-dimensional image (the two-dimensional display mode), a combination of the respective pixels 11R, 11G, and 11B of the three colors that are contiguous in the horizontal direction forms one pixel used to perform the two-dimensional color display (one unit pixel of the 2D color display). FIG. 10 illustrates six unit pixels of the 2D color display in the horizontal direction, and three unit pixels of the 2D color display in the vertical direction.

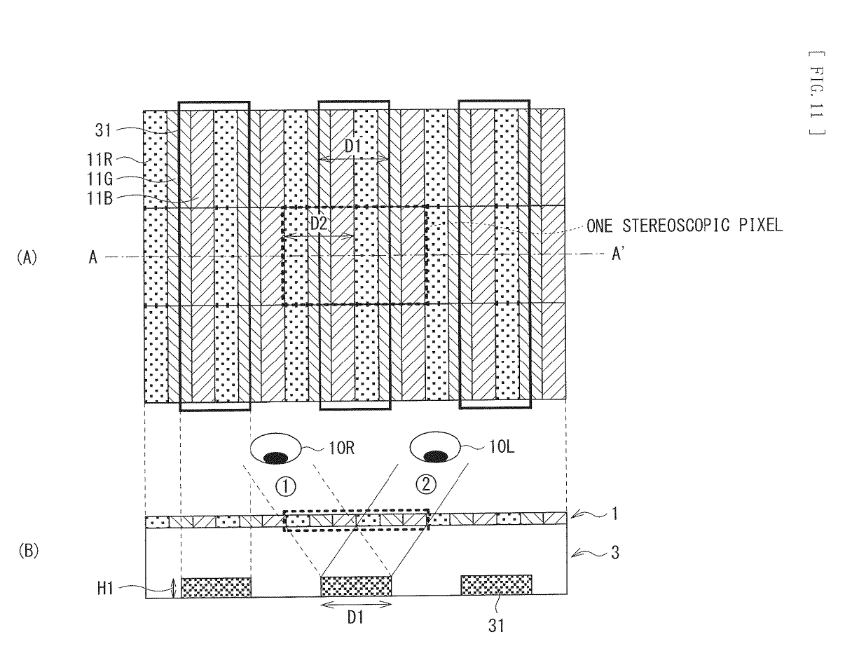

Part (A) of FIG. 11 illustrates an example of the correspondence between an assignment pattern in a case in which two perspective images (a first perspective image and a second perspective image) are assigned to each of the pixels of the display section 1, and the arrangement pattern of the scattering regions 31, in the pixel configuration in FIG. 10. Part (B) of FIG. 11 corresponds to a section of a part A-A′ in Part (A) of FIG. 11. Part (B) of FIG. 11 schematically illustrates a separated state of the two perspective images. In this example, one unit pixel of the 2D color display is assigned as one pixel for display of one perspective image. Further, the pixels are assigned to display the first perspective image and the second perspective image alternately in the horizontal direction. Therefore, two unit pixels of the 2D color display combined in the horizontal direction corresponds to one unit image (one stereoscopic pixel) for the three-dimensional display. As illustrated in Part (B) of FIG. 11, stereoscopic vision is achieved by bringing such a state that the first perspective image reaches only a right eye 10R of a viewer and the second perspective image reaches only the right eye 10R of the viewer. In this example, the scattering region 31 is disposed in the horizontal direction, to be located in a substantially-central part of the one unit image for the three-dimensional display.

Here, a horizontal width D1 of the scattering region 31 has a magnitude having a predetermined relationship with a width D2 of one pixel for displaying one perspective image. Specifically, the width D1 of the scattering region 31 may be preferably a magnitude 0.5 times or more and 1.5 times or less of the width D2. As the width D1 of the scattering region 31 becomes larger, the quantity of light scattered in the scattering region 31 increases, and the quantity of light emitted from the light-guiding plate 3 increases. Therefore, it is possible to increase the luminance. However, when the width D1 of the scattering region 31 exceeds a magnitude 1.5 times the width D2, so-called crosstalk in which light rays from a plurality of perspective images are viewed in a mixed manner, which may be undesirable. Conversely, as the width D1 of the scattering region 31 becomes smaller, the quantity of light scattered in the scattering region 31 decreases, and the quantity of light emitted from the light-guiding plate 3 decreases. Therefore, the luminance declines. When the width D1 of the scattering region 31 is less than 0.5 times the width D2, the luminance is too low, which is too dark for image display and therefore may be undesirable.

[Effects]

As described above, with the display unit according to the present embodiment, the light-guiding plate 3 of the backlight is provided with the function as the parallax barrier. In other words, the first illumination light L1 is scattered by the scattering region 31 of the light-guiding plate 3, and part or all of the light is emitted from the first internal reflection surface 3A towards the display section 1. Therefore, the light-guiding plate 3 itself serves equivalently as the parallax barrier in which the scattering region 31 is used as the opening section (the slit section). Therefore, the number of components is allowed to be reduced, and reduction in thickness is achievable, as compared with a case in which a parallax barrier is provided as a separate component.

In addition, in the present embodiment, the light-guiding plate 3 and the display section 1 are adhered to each other by the adhesion member 4. Therefore, relative positions of the parallax barrier formed in the light-guiding plate 3, and the corresponding pixels 11R, 11G, and 11B of the display section 1 are maintained with high accuracy. For this reason, accuracy of the relative positions of the light-guiding plate 3 and the display section 1 improves, which allows a more-precise parallax image to be achieved.

Moreover, in the present embodiment, when the adhesion member 4 has a property of absorbing or reflecting visible light, it is possible to avoid deterioration of the image quality, by preventing unnecessary light from passing through the adhesion member 4. Further, even when the adhesion member 4 of a transparent type is used, it is possible to prevent occurrence of unnecessary light, by separately providing the thin film 5 having light blocking characteristics or light reflection characteristics. Furthermore, if the adhesion member 4 or the thin film 5 is configured using a material having high reflectance, it is possible to improve the utilization efficiency of the first illumination light L1 from the first light source 2.

[Application Examples]

Next, application examples of the display unit having the illumination unit described above will be described.

The display unit of the present technology is applicable to various kinds of electronic apparatuses having various applications, and the kind of the electronic apparatus is not limited in particular. For example, this display unit may be mounted on the following electronic apparatus. However, a configuration of the electronic apparatus to be described below is only an example, and the configuration may be modified as appropriate.

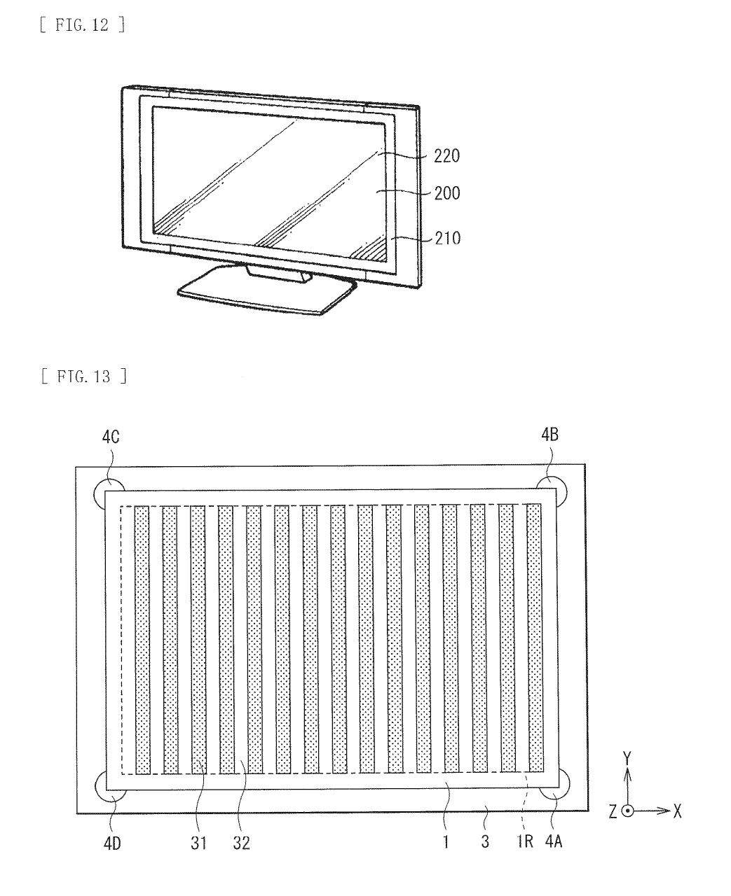

FIG. 12 illustrates an appearance configuration of a television apparatus. This television apparatus may include, for example, an image-display screen section 200 serving as the display unit. The image-display screen section 200 includes a front panel 210 and a filter glass 220.

The display unit of the present technology may be used as an image display part of, for example, a tablet personal computer (PC), a laptop PC, a mobile phone, a digital still camera, a video camera, or a car navigation system, other than the television apparatus illustrated in FIG. 12.

The present technology has been described above with reference to the embodiment and the modification, but the present technology is not limited to the embodiment and the like, and may be variously modified. For example, in the above-described embodiment and the like, the description has been provided with reference to the case in which the light-guiding plate 3 and the display section 1 are adhered by the adhesive serving as the adhesion member 4, but this is not limitative. For example, the light-guiding plate and the display section may be adhered to each other by a reflective tape that is made of Al or the like and has both sides coated with an adhesive.

In addition, in the above-described embodiment and the like, the adhesion member 4 is provided to surround the effective display region 1R of the display section 1 continuously, but this is not limitative. For example, as in a third modification illustrated in FIG. 13, the display section 1 and the light-guiding plate 3 may be locally adhered to each other by four adhesion members 4A to 4D discretely provided on the peripheral edge portion of the display section 1. It is to be noted that arrangement positions of the adhesion members are not limited to those in the example illustrated in FIG. 13, and may be modified as appropriate.

Also, the present technology may adopt the following configurations.

(1)

A display unit including:

an illumination unit including a light-guiding plate; and

a display section adhered to the light-guiding plate to face the light-guiding plate, and performing image display by utilizing light from the light-guiding plate,

the light-guiding plate having first and second internal reflection surfaces facing each other, and

at least one of the first and second internal reflection surfaces being provided with a plurality of scattering regions that scatter first illumination light from outside and allow scattered light travelling from the first internal reflection surface towards the display section to be emitted.

(2)

The display unit according to the above-described (1), wherein

the illumination unit includes a first light source and a second light source, the first light source applying the first illumination light towards inside of the light-guiding plate, and the second light source applying second illumination light from outside towards the second internal reflection surface of the light-guiding plate,

the display section displays an image based on three-dimensional image data and an image based on two-dimensional image data by performing selective switching between the image based on the three-dimensional image data and the image based on the two-dimensional image data,

the first light source is controlled to be in a lighting state when the display section displays the image based on the three-dimensional image data, and the first light source is controlled to be in a non-lighting state or in the lighting state when the display section displays the image based on the two-dimensional image data, and

the second light source is controlled to be in a non-lighting state when the display section displays the image based on the three-dimensional image data, and the second light source is controlled to be in a lighting state when the display section displays the image based on the two-dimensional image data.

(3)

The display unit according to the above-described (1) or (2), wherein the light-guiding plate and the display section are adhered to each other by an adhesion member absorbing or reflecting visible light.

(4)

The display unit according to any one of the above-described (1) to (3), wherein the light-guiding plate and the display section are adhered to each other in whole or a part of a peripheral region surrounding an effective display region.

(5)

The display unit according to any one of the above-described (1) to (4), wherein the light-guiding plate and the display section are adhered to each other by an adhesion member made of a material having a refractive index lower than a refractive index of the light-guiding plate.

(6)

The display unit according to any one of the above-described (1) to (5), further including an optically-transmissive spacer between the light-guiding plate and the display section.

(7)

The display unit according to any one of the above-described (1) to (6), wherein the light-guiding plate and the display section are adhered to each other by an adhesion member that is in contact with an opposing surface of each of the light-guiding plate and the display section, the adhesion member also being in contact with an end face of at least one of the light-guiding plate and the display section.

(8)

An electronic apparatus with a display unit, the display unit including,

an illumination unit including a light-guiding plate; and

a display section adhered to the light-guiding plate, and performing+ image display by utilizing light from the light-guiding plate,

the light-guiding plate having first and second internal reflection surfaces facing each other, and

at least one of the first and second internal reflection surfaces being provided with a plurality of scattering regions that scatter first illumination light from outside and allow scattered light travelling from the first internal reflection surface towards the display section to be emitted.

The present application claims priority on the basis of Japanese Patent Application No. 2011-246775 filed in the Japan Patent Office on Nov. 10, 2011, the entire contents of which is hereby incorporated by reference.

It should be understood by those skilled in the art that various modifications, combinations, sub-combinations, and alterations may occur depending on design requirements and other factors insofar as they are within the scope of the appended claims or the equivalents thereof.

1. A display unit comprising:
an illumination unit including a light-guiding plate; and
a display section adhered to the light-guiding plate to face the light-guiding plate, and performing image display by utilizing light from the light-guiding plate,
the light-guiding plate having first and second internal reflection surfaces facing each other, and
at least one of the first and second internal reflection surfaces being provided with a plurality of scattering regions that scatter first illumination light from outside and allow scattered light travelling from the first internal reflection surface towards the display section to be emitted.

2. The display unit according to claim 1, wherein
the illumination unit includes a first light source and a second light source, the first light source applying the first illumination light towards inside of the light-guiding plate, and the second light source applying second illumination light from outside towards the second internal reflection surface of the light-guiding plate,
the display section displays an image based on three-dimensional image data and an image based on two-dimensional image data by performing selective switching between the image based on the three-dimensional image data and the image based on the two-dimensional image data,
the first light source is controlled to be in a lighting state when the display section displays the image based on the three-dimensional image data, and the first light source is controlled to be in a non-lighting state or in the lighting state when the display section displays the image based on the two-dimensional image data, and
the second light source is controlled to be in a non-lighting state when the display section displays the image based on the three-dimensional image data, and the second light source is controlled to be in a lighting state when the display section displays the image based on the two-dimensional image data.

3. The display unit according to claim 1, wherein the light-guiding plate and the display section are adhered to each other by an adhesion member absorbing or reflecting visible light.

4. The display unit according to claim 1, wherein the light-guiding plate and the display section are adhered to each other in whole or a part of a peripheral region surrounding an effective display region.

5. The display unit according to claim 1, wherein the light-guiding plate and the display section are adhered to each other by an adhesion member made of a material having a refractive index lower than a refractive index of the light-guiding plate.

6. The display unit according to claim 1, further comprising an optically-transmissive spacer between the light-guiding plate and the display section.

7. The display unit according to claim 1, wherein the light-guiding plate and the display section are adhered to each other by an adhesion member that is in contact with an opposing surface of each of the light-guiding plate and the display section, the adhesion member also being in contact with an end face of at least one of the light-guiding plate and the display section.

8. An electronic apparatus with a display unit, the display unit comprising,
an illumination unit including a light-guiding plate; and
a display section adhered to the light-guiding plate, and performing+ image display by utilizing light from the light-guiding plate,
the light-guiding plate having first and second internal reflection surfaces facing each other, and
at least one of the first and second internal reflection surfaces being provided with a plurality of scattering regions that scatter first illumination light from outside and allow scattered light travelling from the first internal reflection surface towards the display section to be emitted.
